(19) United States
(12) Patent Application Publication
(10) Pub. No.: US 2015/0193203 A1
(43) Pub. Date: Jul. 9, 2015

(54) EFFICIENCY IN A FUSED FLOATING-POINT MULTIPLY-ADD UNIT

(71) Applicant: NVIDIA CORPORATION, Santa Clara, CA (US)

(72) Inventors: Srinivasan (Vasu) IYER, Austin, TX (US); David Conrad TANNENBAUM, Austin, TX (US); Stuart F. OBERMAN, Sunnyvale, CA (US)

(73) Assignee: NVIDIA CORPORATION, Santa Clara, CA (US)

(21) Appl. No.: 14/149,647

(22) Filed: Jan. 7, 2014

(51) Int. Cl. G06F 7/544; G06F 7/50

(52) U.S. Cl. CPC G06F 7/5443; G06F 7/50

(57) ABSTRACT

A four cycle fused floating point multiply-add unit includes a radix 8 Booth encoder multiplier that is partitioned over two stages with the compression element allocated to the second stage. The unit further includes an improved shifter design. Processing logic analyzes the input operands, detects values of zero and one, and inhibits portions of the processing logic accordingly. When one of the multiplicand inputs has a value of zero or one, the required multiplication becomes trivial, and the unit inhibits the associated coding logic and data transfer to reduce power consumption. The unit then performs an add-only operation. When the addend input has a value of zero, the addition becomes trivial, and the unit inhibits the improved shifter and data transfer to further reduce power consumption. The unit then performs a multiply-only operation.

### BACKGROUND OF THE INVENTION

1. Field of the Invention

Embodiments of the present invention relate generally to data processing and, more specifically, to improved efficiency in a fused floating point multiply-add unit.

2. Description of the Related Art

In computer systems, in general, and in graphics processing units (GPUs), in particular, a number of arithmetic operations are typically required. The most common operation is termed a fused floating point multiply-add (FFMA) operation. The FFMA operation entails receiving three 32-bit operands, A, B, and C, and computing the value of (A*B+C). Because of the widespread use of the FFMA operation, the design of the FFMA element has significant impact on system performance, particularly with respect to power consumption and latency.

One design decision in the implementation of an FFMA element regards the number of clock cycles allocated to the operation. In a typical FFMA element implemented in four cycles, the first stage includes logic to receive the three input operands, extract the mantissas and exponents, and analyze the relative exponents. The multiplication of the mantissas of the A and B operands occurs in the second stage. The second stage further includes hardware to shift the C operand depending on the relative exponents. Stage three typically includes hardware to add the partial products and implement exponent and sign adjustment, while the final stage consists of leading-zero-detection, normalization, and rounding logic.

In typical computer implementations, the FFMA element is used for a large majority of math operations and may approach 90% usage. In a significant number of these instances, which may approach 30% or more of the total, the C operand is set to zero. In those cases the value of the output is simply the product (A*B). Nevertheless, the input preparation logic analyzes the relative exponent and loads the C operand into the shifter, and the shifter positions the C operand in the second stage regardless of the zero value of the C operand. In this manner, the element generates the final output (A*B+C), where C has a value of zero.

In a significant number of other instances, which may approach 30% or more of the total, the operation is a floating point add (FADD), which is achieved by setting B equal to one. In those cases, the value of the output is simply the sum (A+C). Nevertheless, the multiplier in stage two performs the multiplication, generating the partial products and performing compression. In this manner, the element generates the final output (A*B+C), where B has a value of one. This is equal to the quantity (A+C). As above, the element performs the full FFMA operation without regard to the simplicity of the final result.

As the foregoing illustrates, what is needed in the art is a more effective approach to performing multiply-only and add-only operations in computer systems.

### SUMMARY OF THE INVENTION

A system configured to perform an arithmetic operation, including an arithmetic element configured to receive a first operand, a second operand, and a third operand in a first stage of the arithmetic element, recode the first operand in the first stage of the arithmetic element to generate a first recoded operand, recode the second operand in the first stage of the arithmetic element to generate a second recoded operand, generate a first intermediate term that is three times the first operand, generate a first set of partial products in a second stage of the arithmetic element based on the recoded first operand, the recoded second operand, and the first intermediate term, combine the first set of partial products to generate a first product, and add the first product to the third operand to generate a first result.

One advantage of the disclosed approach is that a substantial reduction in area may be realized along with reduced power usage when performing add-only operations. Further, the improvement of the shifter design allows significant reduction in dynamic power consumption when performing multiply-only operations.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of a parallel processing unit included in the parallel processing subsystem of FIG. 1, according to one embodiment of the present invention;

FIG. 3 is a conceptual diagram of a subsystem configured to support a four cycle fused floating point multiply-add operation, according to one embodiment of the present invention; and

FIG. 4 is a flow diagram of method steps for performing math operations in a segmented FFMA unit, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

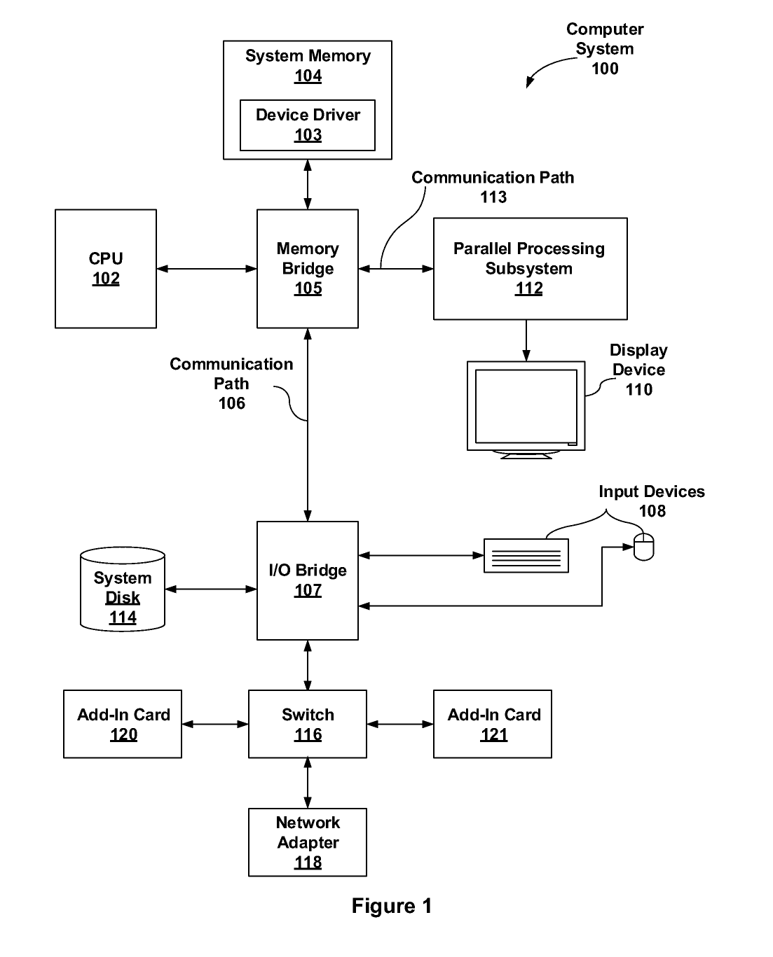

FIG. 1 is a block diagram illustrating a computer system 100 configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

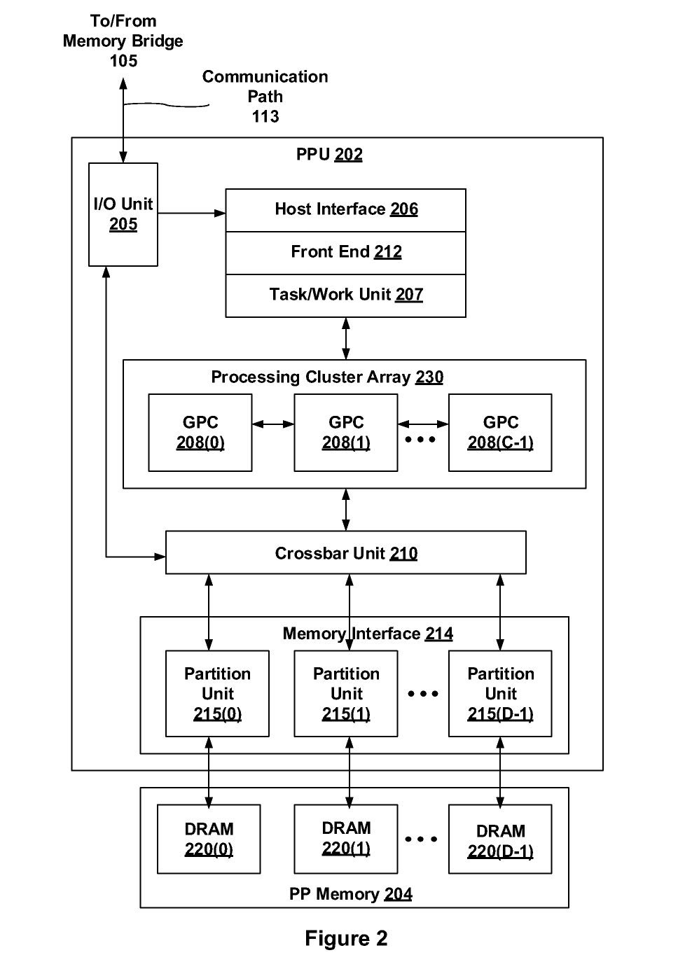

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more of the other elements of FIG. 1 to form a single system. For example, parallel processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the parallel processing subsystem 112 of FIG. 1, according to one embodiment of the present invention. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system on chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end unit 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C 1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D≧1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPC 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

As noted above, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

### Improved Efficiency in a Fused Floating Point Multiply-Add Unit

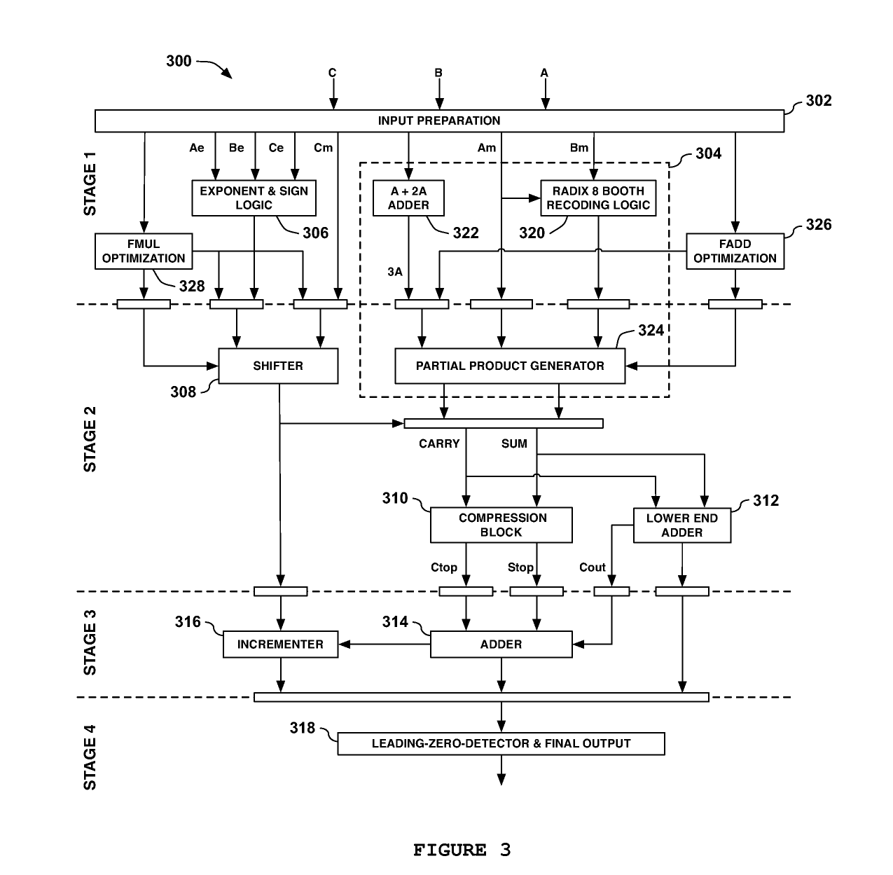

FIG. 3 is a conceptual diagram of a subsystem 300 configured to support a four cycle fused floating point multiply-add operation, according to one embodiment of the present invention. Subsystem 300 may be included within any portion of computer system 100 of FIG. 1. For example, CPU 102 of FIG. 1 or PPU 202 of FIG. 2 may include one or more instances of subsystem 300. Subsystem 300 may be incorporated into any type of computer device, including server machines, desktop machines, laptop computers, mobile devices, handheld devices, and so forth.

As shown, subsystem 300 includes stage 1 through stage 4. Stage 1 includes input preparation 302, exponent and sign logic 306, FMUL optimization 328, and FADD optimizations 326. Multiplier 304 is distributed across stage 1 and stage 2 and includes radix 8 Booth recoding logic 320, A+2A adder 322, and partial product generator 324. Stage 2 includes shifter 308, compression block 310, and lower end adder 312. Stage 3 includes adder 314, and incrementer 316. Stage 4 includes leading-zero-detector & final output 318.

Input preparation 302 receives operands A, B, and C and partitions the mantissa and exponent portions. Multiplier 304 performs the multiplication of the mantissas of the A and B operands. Radix 8 Booth recoding logic formats data for partial product generator 324. A+2A adder 322 creates the 3A signal required for radix 8 processing. Partial product generator 324 creates the nine partial products needed to support radix 8 processing. Exponent and sign logic 306 analyzes the relative exponents of the operands. Shifter 308 positions the C operand for addition with the eight partial products. Compression block 310 combines the partial products to produce carry and sum terms. Lower end adder 312 generates the least significant figures of the sum. Adder 314 adds the upper portions of the carry and sum terms. Incrementer 316 compensates for overflow and sign effects. Leading-zero-detector & final output 318 normalizes the result of the math operations. FADD optimization 326 provides gating signals for add-only operations. FMUL optimization 328 provides gating signals for multiply-only operations.

The full functionality of subsystem 300 is utilized when the three input operands have significant values, that is, when none of them has value of zero or one. In this case, input preparation 302 receives the operands and partitions the mantissas and exponents. Input preparation 302 forwards the mantissas of the A and B operands to multiplier 304, which, as noted, implements a radix 8 Booth encoder. Booth encoding is a conventional approach to performing multiplication in digital systems, which makes use of the fact that a string of ones in a binary number can be broken into the difference of two binary numbers. Operands can thus be deconstructed and coded into simpler, shifted terms and performing simpler operations can replace the multiplication. For radix 8 Booth multiplication, a 3A term is required. Radix 8 Booth recoding logic 320 performs the data preparation required prior to generating the partial products. A+2A adder 322 generates the 3A term. Allocating these functions to the first stage relieves the timing pressure on the second stage. Consequently, the reduced burden on the second stage logic allows a reduction in the area of the second stage.

As the mantissa of a floating point representation of a number is always positive, the last partial product is also positive. This makes it possible to predict the carry out from the addition of the partial products when compressed with the aligned mantissa of the C operand. Thus, adder 314 can sum the wide portion of the final value prior to pre-normalization. This allows incrementer 316 to perform the addition of the higher order bits, thus saving additional area.

When the A operand has a value of zero, the multiply operation becomes trivial. In this case FADD optimization 326 gates off elements as above, and generates the result (A*0+C) or simply C. A corresponding scenario occurs when the B operand has a value of one. In this case FADD optimization 326 gates off elements as above, and generates the result (A+C). As above, subsystem 300 realizes a reduction in power usage. When the B operand is zero, the exponent of the B operand is set to zero.

Input preparation 302 forwards the three exponents to exponent and sign logic 306. Exponent and sign logic 306 analyzes the relative values of the exponents to determine the positioning of the C operand mantissa with respect to the product of the A and B operands. Shifter 308 then appropriately positions the C operand for the subsequent addition. An improved multi-step approach to shifter 308 provides a reduction in operating power by virtue of having a narrower binary word length as well as the ability to inhibit data transfer.

When the C operand has a value of zero, the addition portion of subsystem 300 operation becomes trivial, in that (A*B+C) equals (A*B) when C equals zero. When input preparation 302 determines that the C operand has a value of zero, FMUL optimization 328 gates off shifter 308 and inhibits the data transfer of the C mantissa to shifter 308. FMUL optimization 328 thus provides an improvement in power usage while maintaining an accurate computation result of (A*B)

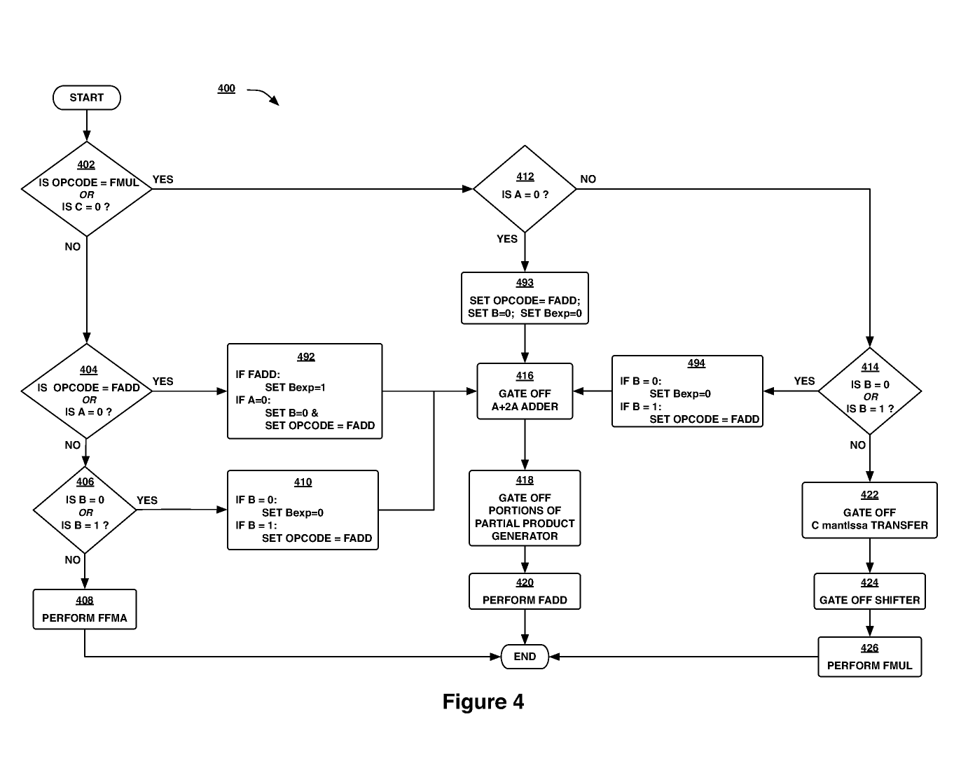

FIG. 4 is a flow diagram of method steps for performing math operations in a segmented FFMA unit, according to one embodiment of the present invention. Although the method steps are described in conjunction with the systems of FIG. 1-3, persons skilled in the art will understand that any system configured to perform the method steps, in any order, is within the scope of the present invention.

In various embodiments, for example, subsystem 300 may be configured to implement the method 400 in order to gate off portions of the FFMA element that are not needed for less complex add-only and multiply-only operations.

As shown, the method 400 begins at step 402, where input preparation 302 determines if the incoming C operand has a value of zero or the opcode is FMUL. If, at step 402, input preparation 302 determines that the incoming C operand has a value of zero or that the opcode is FMUL, then input preparation 302 proceeds to step 412 and continues as discussed below. If, at step 402, input preparation 302 determines that the incoming C operand does not have a value of zero and the opcode is not FMUL, then input preparation 302 proceeds to step 404. At step 404, input preparation 302 determines if incoming A operand has a value of zero or if the opcode is FADD. If, at step 404, input preparation 302 determines that incoming A operand does not have a value of zero and the opcode is not FADD, then input preparation 302 proceeds to step 406. At step 406, input preparation 302 determines if incoming B operand has a value of zero or one. If, at step 406, input preparation 302 determines that incoming B operand does not have a value of zero or one, then input preparation 302 proceeds to step 408. At step 408, FADD optimization 326 enables partial product generator 324 and applies A+2A adder 322 result to partial product generator 324. Further, FMUL optimization 328 enables shifter 308 and applies the mantissa of operand C to shifter 308. Hence, all constituent components of subsystem 300 are active, and subsystem 300 performs a full FFMA operation to generate a final output of (A*B+C).

Returning now to step 404, if input preparation 302 determines that the A operand has a value of zero or that the opcode is FADD, then input preparation 302 proceeds to step 492. At step 492, if input preparation 302 determines that the opcode is FADD, input preparation 302 sets the exponent of operand B to a value of one. Alternatively, if, at step 492, input preparation 302 determines that operand A has a value of zero, input preparation 302 changes the opcode from FFMA to FADD and sets B exponent to a value of zero. Input preparation 302 then proceeds to step 416. At step 416, FADD optimization 326 gates off A+2A adder 322 and proceeds to step 418. At step 418, FADD optimization 326 gates off partial product generator 324 and proceeds to step 420. At step 420, subsystem 300 performs an add-only, or FADD, operation to generate a final output. When the A operand has a value of zero, the final output is simply equal to the C operand. If the opcode is FADD, the output is (A+C)

Returning now to step 406, if input preparation 302 determines that the B operand has a value of zero or one, then input preparation 302 proceeds to step 410. At step 410, if the B operand has a value of one, input preparation 302 maps the opcode from FFMA to FADD. If, at step 410, the B operand has a value of zero, input preparation 302 sets the exponent of operand B to zero. Input preparation 302 then proceeds to step 416. At step 416, FADD optimization 326 gates off A+2A adder 322 and proceeds to step 418. At step 418, FADD optimization 326 gates off partial product generator 324 and proceeds to step 420. At step 420, subsystem 300 performs an add-only, or FADD, operation to generate a final output. When the B operand has a value of one, the final output is equal to (A+C). When the B operand has a value of zero, the final output is simply equal to the C operand.

Returning now to step 412, if input preparation 302 determines that the A operand has a value of zero, then input preparation 302 proceeds to step 493. At step 493, input preparation 302 sets the opcode to FADD, sets the exponent of the B operand to zero, and proceeds to step 416. At step 416, FADD optimization 326 gates off A+2A adder 322 and proceeds to step 418. At step 418, FADD optimization 326 gates off partial product generator 324 and proceeds to step 420. At step 420, subsystem 300 performs an add-only, or FADD, operation to generate a final output. When the A operand has a value of zero, the final output is equal to zero.

If, at step 412, input preparation 302 determines that the A operand does not have a value of zero, then input preparation 302 proceeds to step 414. At step 414, if input preparation 302 determines if operand B has a value of zero or one. If, at step 414, if input preparation 302 determines that operand B has a value of zero or one, then input preparation 302 proceeds to step 494. At step 494, if the B operand has a value of one, input preparation 302 changes the opcode from FFMA to FADD. If, at step 494, the B operand has a value of zero, input preparation 302 sets the exponent of operand B to zero. Input preparation 302 then proceeds to step 416. At step 416, FADD optimization 326 gates off A+2A adder 322 and proceeds to step 418. At step 418, FADD optimization 326 gates off partial product generator 324 and proceeds to step 420. At step 420, subsystem 300 performs an add-only, or FADD, operation to generate a final output equal to (A+C). When the B operand has a value of one, the final output is equal to A, as the C operand has a value of zero at this stage. When the B operand has a value of zero, the final output is equal to zero.

If, at step 414, input preparation 302 determines that operand B does not have a value of zero or one, then input preparation 302 proceeds to step 422. At step 422, FMUL optimization 328 gates off the transfer of the C operand to shifter 308. Input preparation 302 then proceeds to step 424. At step 424, FMUL optimization 328 gates off the shifter 308. Input preparation 302 then proceeds to step 426. At step 426, subsystem 300 performs a multiply-only, or FMUL, operation to generate a final output equal to (A*B).

In sum, a four cycle FFMA unit includes a radix 8 Booth encoder multiplier that is partitioned over two stages with the compression element allocated to the second stage. The unit further includes an improved shifter design. Processing logic analyzes the input operands, detects values of zero and one, and inhibits portions of the processing logic accordingly. When one of the multiplicand inputs has a value of zero or one, the required multiplication becomes trivial, and the unit inhibits the associated coding logic and data transfer to reduce power consumption. The unit then performs an add-only operation. When the addend input has a value of zero, the addition becomes trivial, and the unit inhibits the improved shifter and data transfer to further reduce power consumption. The unit then performs a multiply-only operation.

One advantage of the disclosed approach is that a substantial reduction in area may be realized along with reduced power usage when performing add-only operations. Further, the improvement of the shifter design allows significant reduction in dynamic power consumption when performing multiply-only operations as this allows gating off the shifter logic when performing a floating point multiply (FMUL) operation.

In addition, since a floating point add (FADD) operation involves setting operand B to a value of one, the result of reading operand B ensures that the 3A term is not required to generate the product A*1, or simply A. This allows the (A+2A) term to be gated, resulting in lower power FADD emulation. Finally, the FADD and FMUL are mapped onto the same hardware optimized to perform a full FFMA. As the FADD and FMUL power is lower than the FFMA, one embodiment evaluates the incoming operands when the operation code is FFMA and maps the operation to a FADD or FMUL to lower overall power.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

The invention claimed is:

1. A system configured to perform an arithmetic operation, comprising:
an arithmetic element configured to:
receive a first operand, a second operand, and a third operand in a first stage of the arithmetic element,
recode the first operand in the first stage of the arithmetic element to generate a first recoded operand,
recode the second operand in the first stage of the arithmetic element to generate a second recoded operand,
generate a first intermediate term that is three times the first operand,
generate a first set of partial products in a second stage of the arithmetic element based on the recoded first operand, the recoded second operand, and the first intermediate term,
combine the first set of partial products to generate a first product, and
add the first product to the third operand to generate a first result.

2. The system of claim 1, wherein the arithmetic element includes a multiplication element configured to recode the first operand, recode the second operand, and generate the first set of partial products.

3. The system of claim 2, wherein the multiplication element comprises a radix 8 Booth multiplier.

4. The system of claim 2, wherein the arithmetic element is further configured to:
receive a fourth operand, a fifth operand, and a sixth operand in the first stage of the arithmetic element;
determine that the fourth operand has a value of zero;
gate off the multiplication element; and
generate a second result that is equal to the sixth operand.

5. The system of claim 2, wherein the arithmetic element is further configured to:
receive a fourth operand, a fifth operand, and a sixth operand in the first stage of the arithmetic element;
determine that the fifth operand has a value of zero;
set an exponent associated with the fifth operand to zero; and
gate off the multiplication element; and
generate a second result that is equal to the sixth operand.

6. The system of claim 2, wherein the arithmetic element is further configured to:
receive a fourth operand, a fifth operand, and a sixth operand in the first stage of the arithmetic element;
determine that the fifth operand has a value of one; and
gate off the multiplication element; and
add the fourth operand to the sixth operand to generate a second result.

7. The system of claim 1, wherein the arithmetic element further includes addition logic configured to add the first product to the third operand to generate the first result.

8. The system of claim 7, wherein the arithmetic element is further configured to:
receive a fourth operand, a fifth operand, and a sixth operand in the first stage of the arithmetic element;
determine that the sixth operand has a value of zero;
generate a second intermediate term that is three times the fourth operand;
gate off a portion of the addition logic; and
perform a multiplication operation with the fourth operand, the fifth operand, and the second intermediate term to generate a second result.

9. The system of claim 1, wherein the arithmetic element is configured to add the first product to the third operand by:
combining the first product with a shifted version of the third operand to generate a set of bits associated with the first result; and
incrementing the set of bits to generate the first result.

10. A computer-implemented method for performing an arithmetic operation, the method comprising:
receiving a first operand, a second operand, and a third operand in a first stage of an arithmetic element;
recoding the first operand in the first stage of the arithmetic element to generate a first recoded operand;
recoding the second operand in the first stage of the arithmetic element to generate a second recoded operand;
generating a first intermediate term that is three times the first operand;
generating a first set of partial products in a second stage of the arithmetic element based on the recoded first operand, the recoded second operand, and the first intermediate term;
combining the first set of partial products to generate a first product; and
adding the first product to the third operand to generate a first result.

11. The computer-implemented method of claim 10, further comprising:
receiving a fourth operand, a fifth operand, and a sixth operand in the first stage of the arithmetic element;
determining that the fourth operand has a value of zero;
gating off a multiplication element configured to multiply the fourth operand with the fifth operand; and
generating a second result that is equal to the sixth operand.

12. The computer-implemented method of claim 10, further comprising:
receiving a fourth operand, a fifth operand, and a sixth operand in the first stage of the arithmetic element;
determining that the fifth operand has a value of zero;
setting an exponent associated with the fifth operand to zero;
gating off a multiplication element configured to multiply the fourth operand and the fifth operand; and
generating a second result that is equal to the sixth operand

13. The computer-implemented method of claim 10, further comprising
receiving a fourth operand, a fifth operand, and a sixth operand in the first stage of the arithmetic element;
determining that the fifth operand has a value of one;
gating off a multiplication element configured to multiply the fourth operand and the fifth operand; and
adding the fourth operand to the sixth operand to generate a second result.

14. The computer-implemented method of claim 10, further comprising:
receiving a fourth operand, a fifth operand, and a sixth operand in the first stage of the arithmetic element;
determining that the sixth operand has a value of zero;
generating a second intermediate term that is three times the fourth operand;
gating off a shifter element configured to shift the sixth operand; and
performing a multiplication operation with the fourth operand, the fifth operand, and the second intermediate term to generate a second result.

15. A computing device configured to perform an arithmetic operation, comprising:
an arithmetic element, including:
a multiplication element configured to:
receive a first operand, a second operand, and a third operand in a first stage of an arithmetic element,
recode the first operand in the first stage of the arithmetic element to generate a first recoded operand,
generate a first intermediate term that is three times the first operand,
recode the second operand in the first stage of the arithmetic element to generate a second recoded operand,
generate a first set of partial products in a second stage of the arithmetic element based on the recoded first operand, the recoded second operand, and the first intermediate term;
addition logic configured to:
combine the first set of partial products to generate a first product, and
add the first product to the third operand to generate a first result.

16. The computing device of claim 15, wherein the arithmetic element is further configured to:
receive a fourth operand, a fifth operand, and a sixth operand in the first stage of the arithmetic element;
determine that the fourth operand has a value of zero;
gate off the multiplication element; and
generate a second result that is equal to the sixth operand.

17. The computing device of claim 15, wherein the multiplication element comprises a radix 8 Booth multiplier.

18. The computing device of claim 15, wherein the addition logic includes a shifter configured to shift the third operand to generate a shifted version of the third operand.

19. The computing device of claim 18, wherein the addition logic adds the first product to the third operand by:
combining the first product with the shifted version of the third operand to generate a set of bits associated with the first result;
incrementing the set of bits to generate the first result.

20. The computing device of claim 19, wherein the arithmetic element is further configured to:
receive a fourth operand, a fifth operand, and a sixth operand in the first stage of the arithmetic element;
determine that the sixth operand has a value of zero;
generate a second intermediate term that is three times the fourth operand;
gate off a portion of the addition logic; and
perform a multiplication operation with the fourth operand, the fifth operand, and the second intermediate term to generate a second result.
